(19) United States
(12) Patent Application Publication
(10) Pub. No.: US 2026/0299537 A1
(43) Pub. Date: Oct. 1, 2026

(54) AUTOMATION BRIDGE FOR CONNECTING AUTOMATION SYSTEMS TO POOL EQUIPMENT NETWORKS

(71) Applicant: BELLSON ELECTRIC PTY LTD, Caringbah NSW (AU)

(72) Inventor: David John Sanson, Taren Point NSW (AU)

(21) Appl. No.: 19/629,522

(22) Filed: Mar. 26, 2026

Related U.S. Application Data
(60) Provisional application No. 63/780,043, filed on Mar. 28, 2025.

(51) Int. Cl. G05B 15/02; G05B 23/02; E04H 4/12

(52) U.S. Cl. CPC G05B 15/02; G05B 23/0283; E04H 4/12

(57) ABSTRACT

A swimming pool equipment control system for integrating automation platforms and pool equipment networks has a pool equipment network configured to receive one or more translated command outputs. The pool equipment network has one or more sensors configured to transmit one or more data inputs. An autonomous platform configured to output one or more command signals based on the data inputs. The automation bridge is communicatively connected to the one or more automation systems and one or more pool equipment systems, wherein the automation bridge is configured to intercept the one or more command signals from the autonomous platform via a code receiving unit, process the one or more command signals via a processor unit, translate the one or more command signals into one or more consolidated command outputs readable by the pool equipment network, and send the one or more consolidated command outputs to the pool equipment network.

### CROSS REFERENCE TO RELATED APPLICATION

This application claims benefit of U.S. Provisional Application Serial No. 63/780,043 entitled, “Lighting Control Module for Connecting Automation Systems to Lights” filed Mar. 28, 2025, the entire disclosure of which is incorporated herein by reference.

### FIELD OF THE DISCLOSURE

The present disclosure is generally related to automation bridges and more particularly is related to automation bridges for connecting automation systems to pool equipment networks.

### BACKGROUND OF THE DISCLOSURE

Pool equipment such as heaters, pumps, valves, water features, and lighting systems are used with most swimming pools to provide upkeep, cleanliness, and leisure. Conventional automation platforms provide separate fragmented control due to specific wiring and input compatibility of pool equipment components. This is, in part, due to the need to have completely watertight lights and other pool infrastructure, such that controlling the equipment network must be done from a remote location to limit the risk of water infiltration into the pool equipment. For example, pool lighting systems are often designed to generate control signals in a remote automation system, which then transmits signals through the wiring to control various modes and colors of the lights. Accordingly, several protocols and methods to operate and power such pool systems exist, which are operated using independent hardware and controllers which are compatible with only certain types of wiring schemes and command codes. Certain wiring methods and protocols, however, may not be able to achieve all desired functions, and may require a user to install multiple systems each with unique wiring schemes.

### SUMMARY OF THE DISCLOSURE

Embodiments of the present disclosure provide a swimming pool equipment control system for integrating automation platforms and pool equipment networks. Briefly described, in architecture, one embodiment of the system, among others, can be implemented as follows. A pool equipment network is configured to receive one or more translated command outputs. The pool equipment network has one or more sensors configured to transmit one or more data inputs. An autonomous platform configured to output one or more command signals based on the data inputs. The automation bridge is communicatively connected to the one or more automation systems and one or more pool equipment systems, wherein the automation bridge is configured to intercept the one or more command signals from the autonomous platform via a code receiving unit, process the one or more command signals via a processor unit, translate the one or more command signals into one or more consolidated command outputs readable by the pool equipment network, and send the one or more consolidated command outputs to the pool equipment network.

The present disclosure can also be viewed as providing a method for integrating automation platforms and pool equipment networks. In this regard, one embodiment of such a method, among others, can be broadly summarized by the following steps and features: transmitting one or more data inputs via one or more sensors communicatively connected to a pool equipment network, outputting one or more command signals based on the data inputs via an autonomous platform, the autonomous platform having one or more automation systems, communicatively connecting an automation bridge to the automation platform and the pool equipment network, wherein the automation bridge is configured to intercept the one or more command signals from the autonomous platform via a code receiving unit, process the one or more command signals via a processor unit, translate the one or more command signals into one or more consolidated command outputs readable by the pool equipment network, and send the one or more consolidated command outputs to the pool equipment network.

The present disclosure can also be viewed as providing a swimming pool lighting control system for connecting automation systems to lights. Briefly described, in architecture, one embodiment of the system, among others, can be implemented as follows. An autonomous platform having one or more automation systems, the autonomous platform configured to output one or more command signals. The system has one or more lights and a lighting control module configured to intercept a command signal output by at least one automation system, process a command signal via a processor unit, translate the command signal into a consolidated command output, and send the consolidated command output to at least one light having an input differing from the command signal output, wherein the at least one light is configured to receive the consolidated command output.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a schematic illustration of a swimming pool equipment control system for integrating an automation platform and a pool equipment network, in accordance with the present disclosure.

FIG. 2 is a schematic illustration of a swimming pool lighting control system, in accordance with the present disclosure.

FIG. 3 is a schematic illustration of the processing of an intercepted communication signal using an automation bridge, in accordance with the present disclosure.

FIG. 4 is a flowchart illustrating a method for integrating automation platforms and pool equipment networks, in accordance with the disclosure.

### DETAILED DESCRIPTION

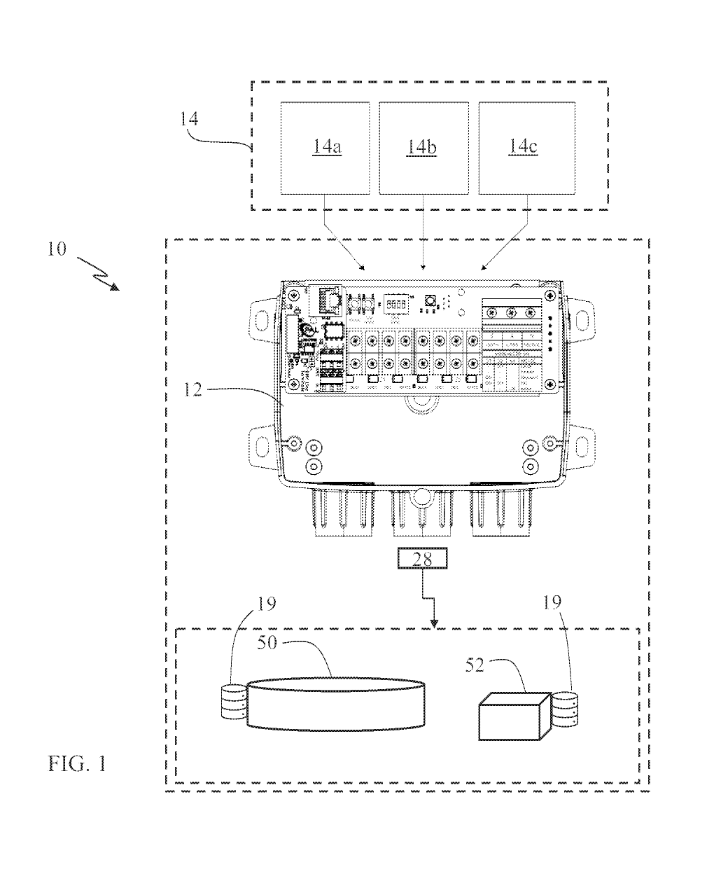

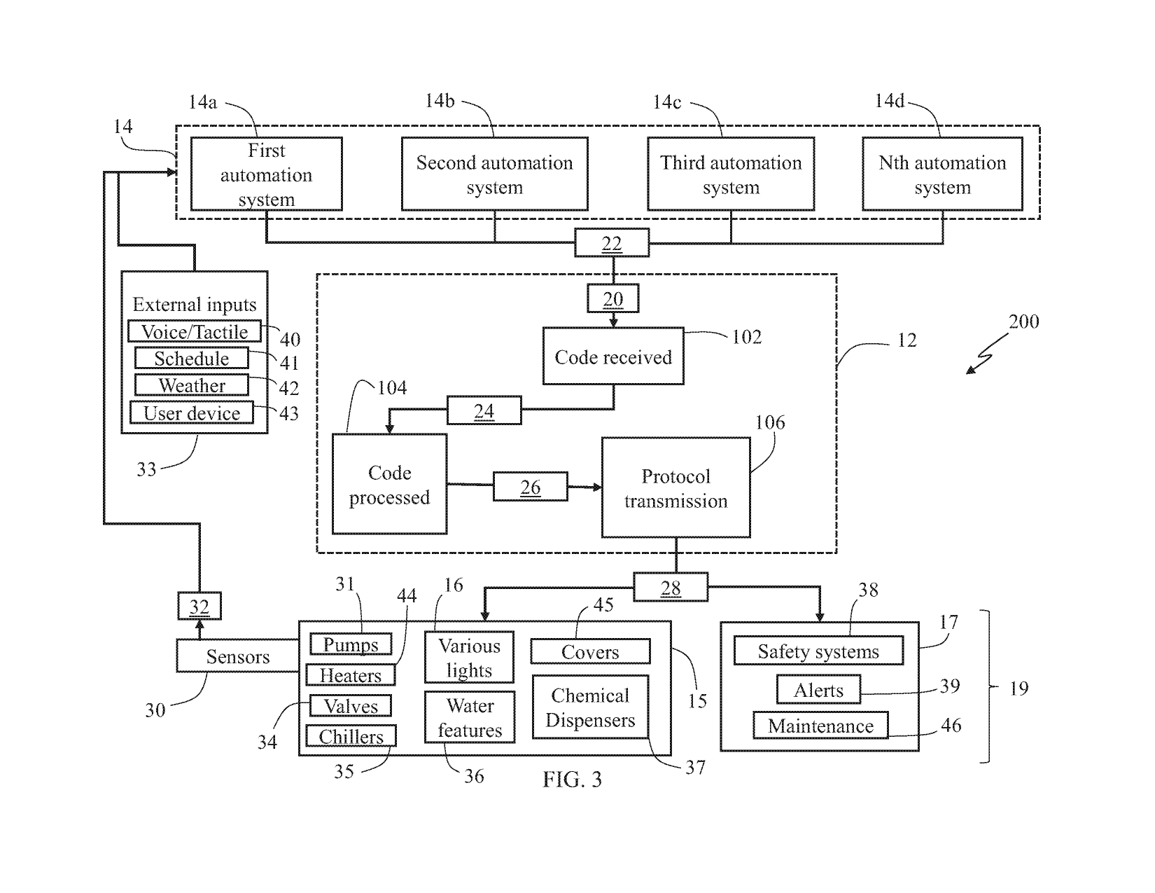

FIG. 1 is a schematic illustration of a swimming pool equipment control system 10 for integrating an automation platform and a pool equipment network, in accordance with the present invention, which includes an automation bridge 12. The automation bridge 12 (hereinafter “controller 12”) may be a controller 12 that is configured to receive, translate, or intercept short-range wireless communications from the automation platform 14. The automation platform 14 may include at least one of a first automation system 14a, a second automation system 14b, a third automation system 14c, or any other additional numbers of automation systems 14. Each automation system 14a, 14b, 14c may have a predetermined short-range wireless communication code or method. This short-range wireless communication code or method may correspond to controlling the pool equipment network 19. The controller 12 may be a bridge between the automation platform 14 and pool equipment network 19 to provide protocol translation and device orchestration. The pool equipment network 19 may include pool infrastructure 15 and/or a safety unit 17 (shown in FIG. 3). The controller 12 may allow seamless integration between residential and/or commercial building automation systems 14 and the pool equipment network 19, which may facilitate centralized monitoring, control, and/or optimization of the pool infrastructure 15 and/or safety unit 17. The controller 12 may include microprocessors, drivers, and/or receivers configured for serial communication. The controller 12 may have input and/or output relay to provide direct equipment switching and automation logic between the automation system 14 and pool equipment network 19.

The pool equipment network 19 may include pool infrastructure 15 and/or a safety unit 17. The pool infrastructure 15 may include aquatic equipment, lighting systems, and environmental sensors 30. As shown in FIG. 3, the pool infrastructure 15 may be any pool 50 equipment such as lights 16, water pumps 31, heaters 44, sensors 30, chemical dispensers 37, retractable covers 45, landscape features, and/or the like. For example, the controller 12 may control pool 50 and/or spa 52 heating systems, lighting systems 16 for a pool 50, spa 52, landscape, and/or water features 36, water pumps 31, valves/actuators 34, one or more water features 36, pool 50/spa 52 covers 45, and/or safety systems 38. The one or more water features 36 may include water jets, fountains, waterfalls, and/or the like. Other controllable features may include landscape features such as tree lighting, patio lighting, activation of movable/retractable components, and/or the like. The safety unit 17 may include various safety alerts 39 and/or safety monitoring systems 38. The safety monitoring systems 38 may monitor and/or detect harmful chemical levels or temperatures of a pool 50 and/or spa 52. The safety monitoring systems 38 may monitor and/or detect hazardous weather 42 conditions and communicate with the autonomous platform 14 and/or controller 12 accordingly.

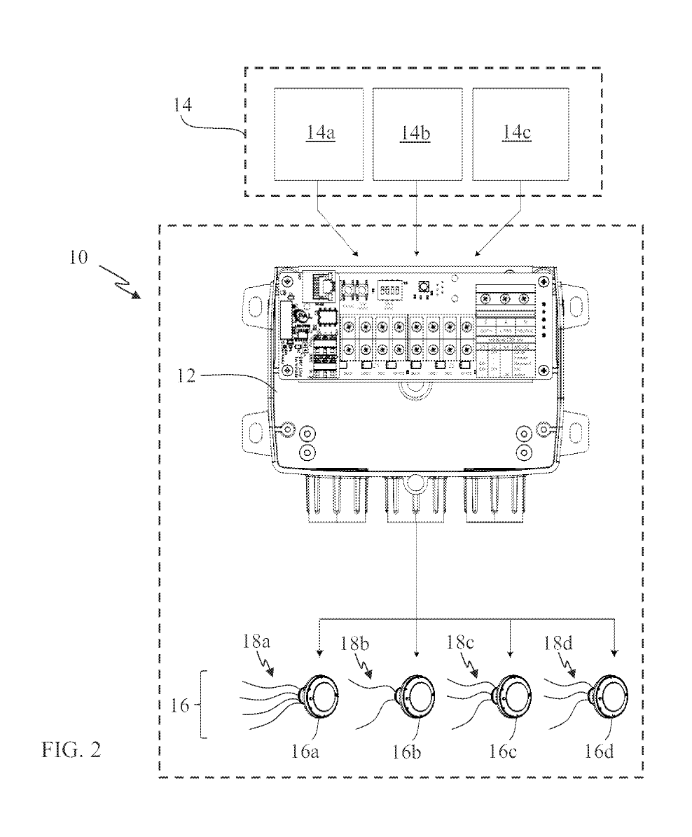

FIG. 2 is a schematic illustration of a swimming pool equipment control system 10, in accordance with the present disclosure. The pool infrastructure 15 may include various lights 16. The various lights 16 may include a first light 16a, a second light 16b a third light 16c, and/or a fourth light 16d. In one example, each light 16a, 16b, 16c, 16d of the various lights 16 may be configured to have different wiring schemes. Each of the wiring schemes may correspond to a communication code or method thereof of a given automation system 14. In other words, a communication code or method thereof of a given automation system 14 may be configured such that that a signal 32 or communication be sent to one of the various lights 16 through a specified wiring scheme. In one example, certain communication codes or methods thereof may have a first light 16a that has a four-wire wiring scheme 18a. Any one of the various automation systems 14 may be configured to communicate with the light 16a having the four-wire wiring scheme 18a while the remainder of the various automation systems 14 may be unable to communicate with the first light 16a having the four-wire wiring scheme 18a in the absence of the controller 12.

In another example, certain communication codes or methods thereof may be configured such that a second light 16b has a two-wire wiring scheme 18b. Any one of the various automation systems 14 may be configured to communicate with the second light 16b having the two-wire wiring scheme 18b while the remainder of the various automation systems 14 may be unable to communicate with the second light 16b having the two-wire wiring scheme 18b in the absence of the controller 12.

In another example, certain communication codes or methods thereof may be configured such that a third and fourth light 16c, 16d have a three-wire wiring scheme 18c, 18d. Any one of the various automation systems 14 may be configured to communicate with the third and fourth light 16c, 16d having the three-wire wiring scheme 18c, 18d while the remainder of the various automation systems 14 may be unable to communicate with the third and fourth light 16c, 16d having the three-wire wiring scheme 18c, 18d in the absence of the controller 12. Furthermore, in such an example where each third and fourth light 16c, 16d has the same three-wire wiring scheme 18c, 18d, there may still be differences in the configuration of the three-wiring wiring scheme 18c, 18d, such that cross communication between the third and fourth lights 16c, 16d with three-wire wiring schemes 18c, 18d may still not be possible absent the controller 12.

The controller 12 enables any of the first, second, third, and fourth 16a, 16b, 16c, 16d of the various lights 16 to be interchangeably controlled by any of the first, second, and third automation systems 14a, 14b, 14c of the various automation systems 14. For example, the first automation system 14a may be conventionally configured to operate with, connect to, and communicate with the first light 16a, which may have the four-wire wiring scheme 18a. The controller 12 may intercept this communication and process it such that the communication sent by the first automation system 14a is able to control any one or two of the various lights 16 that have a wiring scheme different from what the first automation system 14a is conventionally configured to operate with. In such an example, in addition to the first automation system 14a controlling its respective first light 16a, the first automation system 14a may also be able to control the second light 16b having a two-wire wiring scheme 18b. The first automation system 14a may also be able to control the third and fourth lights 16c, 16d, each having a three-wire wiring scheme 18c, 18d.

In another example, the second automation system 14b may be conventionally configured to operate with, connect to, and communicate with the second light 16b, which may have the two-wire wiring scheme 18b. The controller 12 may intercept this communication and process it such that the communication sent by the second automation system 14b is able to control any one or two of the various lights 16 that have a wiring scheme different from what the second automation system 14b is conventionally configured to operate with. In such an example, in addition to the second automation system 14b controlling its respective second light 16b, the second automation system 14b may also be able to control the first light 16a having a four-wire wiring scheme 18a. The second automation system 14b may also be able to control the third and fourth lights 16c, 16d, each having a three-wire wiring scheme 18c, 18d.

In a further example, the third automation system 14c may be conventionally configured to operate with, connect to, and communicate with one of or both of the third and fourth light 16c, 16d, which may have the three-wire wiring scheme 18c,18d. The controller 12 may intercept this communication and process it such that the communication sent by the third automation system 14c is able to control any one or two of the various lights 16 that have a wiring scheme different from what the third automation system 14c is conventionally configured to operate with. In such an example, the third automation system 14c may be able to control the first light 16a having a four-wire wiring scheme 18a. The third automation system 14c may also be able to control the second light 16b having a two-wire wiring scheme 18b. The third automation system 14c may also be able to control either one of the third or fourth lights 16c, 16d even if the wiring configuration of each of the third or fourth lights differs 16c, 16d. The control over other various lights 16 may be enabled in addition to the conventional configuration and operation of each of the first, second, and third 14a, 14b, 14c automation system 14 with each of its respective first, second, third, and/or fourth 16a, 16b, 16c, 16d light 16.

FIG. 3 is a schematic illustration 200 of the processing of an intercepted communication signal using an automation bridge, in accordance with the present disclosure. It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

Any one of the first automation system 14a, second automation system 14b, third automation system 14c, and any additional automation systems 14d may be conventionally configured to operate with, connect to, and communicate with a specified type of pool infrastructure 15 and/or safety unit 17. In one example where communication is between each of the automation systems 14a, 14b, 14c, 14d and one or more lights 16, the communication may be based on the wiring scheme of the specified type of pool infrastructure 15 or safety unit 17 based on the communication protocol used. In one example, the first, second, third, and any additional automation system 14a, 14b, 14c, 14d may communicate to a specified type of light among the various lights 16 using a DMX/Modbus protocol to control characteristics of the lights among the various lights 16. The DMX/Modbus protocol may operate by using a serial communication standard, such as the RD-485 communication standard. This connects an automation system to the automation system 14a, 14b, 14c, 14d, which is then able to communicate to a specified type of light among the various lights 16 by pulse-width modulation (PWM) or other communication schemes.

The controller 12 and/or automation platform 14 may communicate to the pool equipment network 19 using a standard interface for serial communication such as a RS485 and/or serial communication protocol. For example, the controller 12 and/or automation platform 14 may communicate with one or more water pumps 31, valves 34, heaters 44, or chillers 35 using a RS485 and/or serial protocol to control activation, speed, and/or flowrate thereof. The controller 12 and/or automation platform 14 may communicate with one or more chemical dispenser/injectors 37 using the a RS485 and/or serial communication protocol to control the frequency, quantity, and/or type of chemical dispensing. It may be appreciated that various components of the pool equipment network 19 may require various communication protocols and that the controller 12 may support other communication schemes for outputting a consolidated command output 28 to the pool equipment network 19. Other communication types may be used, for example, relay, I/O, Ethernet, Wi-Fi, for communication between the pool equipment network 19 and the controller 12 and/or automation platform 14.

In FIG. 3, at least one of the automation systems 14a, 14b, 14c, 14d may receive a data signal 32 from one or more sensors 30 disposed in or around the pool 50 and/or spa 52. The sensors 30 may detect, measure, and/or determine water chemical levels, temperature values, valve 34 and/or pump 31 flowrate, and/or energy load of the pool infrastructure 15. The one or more sensors 30 may output a data signal 32 to the automation platform 14 and/or controller 12. The automation platform 14 may output a command signal 22, which may be a short-range wireless signal, long-range wireless signal, or a signal carried through data wire or other physical methods. The command signal 22 may be based on one or more data signals 32 received from the one or more sensors 30. The command signal 22 may be based on various automation systems 14a, 14b, 14c, 14d such as a smart home systems, or any other autonomous system 14 in a home, office building, commercial venue, hotel, vacation resort, and/or the like. The controller 12 may be configured to intercept any of the command signals 22 output by any one or more of the automation systems 14a, 14b, 14c, 14d. The command signal 22 may be captured by or intercepted by the controller 12 as an intercepted communication signal 20 at a code receiving unit 102 of the controller 12. The intercepted communication signal 20 received, which may be understood as a received intercepted communication signal 24, is then sent to a processor unit 104. At the processor unit 104, the received intercepted communication signal 24 is processed, where the communication code used by any one of the first, second, third, or additional automation system 14a, 14b, 14c, 14d is translated or consolidated into a code readable by the hardware components of the controller 12. The consolidated code 26 is then sent to a protocol transmission unit 106, where the consolidated code 26 is in a form that is readable by the protocol transmission unit 106. Accordingly, the protocol transmission unit 106 is able to send out a translated and/or consolidated command output 28 to pool infrastructure 15 and/or safety unit 17. The consolidated command output 28 generated may be able to influence or affect the one or more pool 50 equipment, and may direct the one or more pool infrastructure 15 and/or safety unit 17 to complete an operation. In one example, the consolidated command output 28 may influence or affect a light within the various lights16 that may otherwise not be able to be influenced or affected by the original command signal 22. In another example, a single command signal 22 from one of the first, second, third, or other automation system 14a, 14b, 14c, 14d may be able to influence or affect multiple lights within the various lights 16, where such a command signal 22 would otherwise only affect one light within the various lights 16.

For example, the autonomous platform 14 may monitor the pool equipment network 19 with the use of one or more sensors 30 disposed in and/or around the pool 50. The sensors 30 may be directly affixed or communicatively connected to the pool infrastructure 15 and/or safety unit 17. The one or more sensors 30 may be communicatively connected to the controller 12 and/or the automation platform 14 with ethernet or Wi-Fi connection. The data signal 32 may be sent to the automation platform 14. The data signal 32 may include data on the detection, measurement, and/or determination of water chemical levels, temperature values, valve 34 and/or pump 31 flowrate, and/or energy load of the pool 50 infrastructure 15.The automation platform 14 may output a command signal 22 based on thereon, which may be captured by or intercepted by the controller 12 as an intercepted communication signal 20 at the code receiving unit 102 of the controller 12. The intercepted communication signal 20 may be sent to the processor unit 104. The processor unit 104 may intercept and process the communication signal 24, where the communication code used by any one of the first, second, third, or additional automation system 14a, 14b, 14c, 14d may be translated or consolidated into a code readable by the hardware components of the controller 12. The consolidated code 26 may be sent to a protocol transmission unit 106, where the consolidated code 26 is in a form that is readable by the protocol transmission unit 106. The protocol transmission unit 106 may send out a translated and/or consolidated command output 28 to the pool equipment network 19. In some examples, the translated command may be communicated to a heat pump 31 for increasing a water temperature, or communicated to a pool 50 chiller 35 to decrease the water temperature. The translated command may be communicated to a valve 34 and/or water pump 31 to increase a flowrate or decrease the flowrate.

In one example, the automation platform 14 may monitor and/or control the chemical levels in a pool 50. The chemicals may correspond to a pH value, chlorine, sanitization level, oxidation reduction potential (OPR), alkalinity, calcium hardness, cyanuric acid, salinity level, and/or the like. For example, the controller 12 may adjust the pH level determined by the one or more sensors 30 in the pool 50. In some examples, if the pH level is determined and/or detected to fall below a threshold via the one or more sensors 30, a data signal 32 may be sent to the automation platform 14. The automation platform 14 may output a command signal 22, which may be captured or intercepted by the controller 12 as an intercepted communication signal 20 at the code receiving unit 102 of the controller 12. The intercepted communication signal 20 may be sent to the processor unit 104. The processor unit 104 may intercept and process the communication signal 24, where the communication code used by any one of the first, second, third, or additional automation system 14a, 14b, 14c, 14d may be translated or consolidated into a code readable by the hardware components of the controller 12. The consolidated code 26 may be sent to a protocol transmission unit 106, where the consolidated code 26 is in a form that is readable by the protocol transmission unit 106. The protocol transmission unit 106 may send out a translated and/or consolidated command output 28 to one or more of the pool infrastructure 15 and/or safety unit 17. The translated command may cause a chemical dispenser 37 to adjust the pH level to a desired level and/or range.

The chemical dispenser 37 may inject one or more chemicals into the pool 50 and/or spa 52 to adjust the one or more chemical levels. In one example, the automation platform 14 may monitor, detect, and control an OPR of a pool 50 with one or more sensors 30. In another example, the automation platform 14 may monitor, control, and detect a pool 50 sanitization level. For example, if the one or more sensors 30 detect a chlorine level falling below a threshold sanitization level, the controller 12 may receive and translate a command signal 22 from the automation platform 14 to add chlorine to the pool 50 continuously or incrementally until the desired sanitization level is achieved. If the one or more sensors 30 detect a chlorine level above a threshold sanitization level, the controller 12 may receive and translate a command signal 22 from the automation platform 14 to alert 39 a user via the safety unit 17 that the pool 50 sanitization level is too high and/or low for pool 50 use. In some examples, the data input 32 may detect, measure, and/or indicate the presence of algae, E. coli, pseudomonas aeruginosa, or other harmful microbes and/or biological growth. In some examples, the automation platform 14 may monitor and/or adjust the calcium hardness, cyanuric acid level, and/or alkalinity level of the pool 50 and/or spa 52 water with the chemical dispensers 37. The threshold values of the one or more chemicals may be preprogrammed into the automation platform 14 and may be adjusted by the user.

The automation platform 14 may monitor and/or control a water temperature of the pool 50 and/or spa 52 with one or more sensors 30. For example, if the one or more sensors 30 detect a water temperature falling below a threshold temperature value, the controller 12 may receive and translate a command signal 22 from the automation platform 14 to communicate to the pool infrastructure 15 to activate a heat pump 31. The heat pump 31 may increase the water temperature of the pool 50 and/or spa 52 until a desired temperature level is reached. If the one or more sensors 30 detect a water temperature above a desired water temperature level, the controller 12 may receive and translate a command signal 22 from the automation platform 14 to communicate to the pool infrastructure 15 to activate a pool 50 chiller 35. The pool 50 chiller 35 may lower the water temperature of the pool 50 until a desired temperature is reached. The threshold and/or desired values of the pool 50 and/or spa 52 water temperature may be preprogrammed into the automation platform 14 and may be adjusted by the user.

The automation platform 14 may monitor and/or control the flowrate in one or more pumps 31 and/or valves 34 using one or more flow sensors 30. For example, if the one or more flow sensors 30 detect a flowrate of a pump 31 and/or valve 34 above a threshold level, the controller 12 may receive and translate a command signal 22 from the automation platform 14 to communicate to the pool infrastructure 15 to decrease the flowrate to a safe and/or energy efficient flow rate. If the one or more flow sensors 30 detect a flowrate of a pump 31 and/or valve 34 falling below a threshold level the controller 12 may receive and translate a command signal 22 from the automation platform 14 to communicate to the pool infrastructure 15 to increase the flowrate to a desired level. The threshold and/or desired values triggering valve 34 actuation and/or pump 31 speed may be preprogrammed into the automation platform 14 and may be adjusted by the user.

The automation platform 14 may monitor and/or control various water features 36 disposed on, in, or around the pool 50 and/or spa 52. For example, the controller 12 may receive and translate a command signal 22 from the automation platform 14 for activating/deactivating a water feature 36. The activation and/or deactivation of the one or more water features 36 may correspond to actuation of one or more valves 34, as discussed earlier herein. Accordingly, the protocol transmission unit 106 is able to send out a translated and/or consolidated command output 28 to pool infrastructure 15 and/or safety unit 17. The consolidated command output 28 generated may be able to influence or affect the one or more water features 36, and may direct the one or more water features 36 to complete an operation. In one example, the consolidated command output 28 may influence or affect a water feature 36 that may otherwise not be able to be influenced or affected by the original command signal 22. In another example, a single command signal 22 from one of the first, second, third, or other automation system 14a, 14b, 14c, 14d may be able to influence or affect multiple water features 36 within, on, or around the pool 50 and/or spa 52, where such a command signal 22 would otherwise only affect one water feature 36.

The consolidated command output 28 may influence or affect the safety unit 17. For example, the consolidated command output 28 may direct a pool 50 cover 45 to open and/or close based on the controller 12 receiving a command signal 22 from the autonomous platform 14. The cover 45 may be automatically locked or otherwise secured depending on the time of day and/or year.

In some examples, the one or more data signals 32 are sent to the controller 12. The controller 12 may monitor the pool equipment network 19 with the use of one or more sensors 30 disposed in and/or around the pool 50. The sensors 30 may be directly affixed or communicatively connected to the pool infrastructure 15 and/or safety unit 17. The data signal 32 may be sent to the controller 12. The data signal 32 may include data on the detection, measurement, and/or determination of water chemical levels, temperature values, valve 34 and/or pump 31 flowrate, and/or energy load of the pool equipment network 19. The protocol transmission unit 106 may send out a consolidated command output 28 to the pool equipment network 19. In another example, the consolidated command output 28 may be communicated to chemical dispenser 37 to increase/decrease the amount of chlorine in the pool 50 until the desired sanitization level is achieved. In some examples, the consolidated command output 28 may be communicated to chemical dispensing unit to increase/decrease the alkalinity level, calcium harness, cyanuric acid level, pH, and/or OPR of the pool 50 and/or spa 52 water to a desired amount and/or range. The consolidated command output 28 may be communicated to a heat pump 31 for increasing a water temperature, or communicated to a pool 50 chiller 35 to decrease the water temperature. The consolidated command output 28 may be communicated to a valve 34 and/or water pump 31 to increase/decrease a flowrate and/or pump speed.

The controller 12 may monitor and/or control the flowrate in one or more pumps 31 and/or valves 34 using one or more flow sensors 30. For example, if the one or more flow sensors 30 detect a flowrate of a pump 31 and/or valve 34 above a threshold level, the controller 12 may communicate to the pool infrastructure 15 to decrease the flowrate to a safe and/or energy efficient flow rate. If the one or more flow sensors 30 detect a flowrate of a pump 31 and/or valve 34 falling below a threshold level, the controller 12 may communicate to the pool infrastructure 15 to increase the flowrate to a desired level.

The automation platform 14 command signals 22 may be automatically transmitted based on sensor 30 data inputs 32. The automation platform 14 may transmit command signals 22 based on external inputs 33. External inputs 33 may include voice and/or tactile inputs 40 from a user. In some examples, the user may input an activation schedule 41 for the pool infrastructure 15 and/or safety unit 17. Exernal inputs 33 may be one or more weather 42 patterns, which may be automatically detected by one or more sensors 30 and/or communicatively received by an external weather 42 database. The one or more weather 42 patterns may include air temperature, wind speed and/or direction, humidity, cloud coverage, UV index, dew point, and/or the like.

The automation platform 14 command signals 22 may be based on and/or manually transmitted via an automation app on a user device 43. The automation platform 14 may communicate with a user through control interface and/or display interface coupled to a display. The automation app may include a user interface to provide a user with an automation dashboard. The automation app may have predetermined control groupings allowing a user to group and predefine pool infrastructure 15 settings. For example, the automation app may include a pool 50 party setting, where the user may select personalized pool infrastructure 15 settings. Other predetermined control groupings may include a night-mode setting, a maintenance-mode setting, energy saving protocol, and/or the like. As used herein, ‘user device 43’ may be a smart electronic device capable of communicating with various other electronic devices and applications via one or more communication networks. Examples of said user device 43 include, but are not limited to, a wireless communication device, a smart phone, a tablet, a desktop, a laptop, etc.

The automation app may be integrated with other home or building automation systems to allow for comprehensive control of a unified automation platform 14. The automation app may allow a user to schedule 41 command signals 22. The automation platform 14 may be integrated into a larger home automation ecosystem and/or smart home and may transmit command signals 22 based thereon. The automation ecosystem may be any home, office building, commercial venue, hotel, vacation resort, and/or the like. The integration with an automation ecosystem allows for a single, unified interface. The command signals 22 may be scheduled 41 alongside or in response to various automation commands related to other home functions. In one nonlimiting example, the automation platform 14 may be scheduled 41 to transmit a command signal 22 to heat the pool 50 when a garage door is opened on a weekday afternoon.

The automation platform 14 may output command signals 22 which may be transmitted and/or scheduled 41 based on weather 42 factors. The command signals 22 based on weather 42 factors may be received and translated by the controller 12 to activate a heat pump 31 when an ambient air temperature falls below a threshold. The command signals 22 based on weather 42 factors may be received and translated by the controller 12 to activate a pool 50 chiller 35 when an ambient air temperature rises above a threshold.

The automation platform 14 may transmit command signals 22 based on energy utilization. The automation platform 14 may automatically detect energy efficiencies based on pump 31, valve 34, or other pool infrastructure 15 usage. The automation platform 14 may apply artificial intelligence and/or a machine learning model to measure, analyze, interpret, and organize sensor 30 data inputs 32 to determine if one or more of the pool infrastructure 15 is running inefficiently. The automation platform 14 may initiate an energy saving protocol based on an identified energy consumption of the pool equipment network 19. The energy saving protocol may place upper and lower limits on one or more of the pool equipment network 19. The upper and/or lower limits may be based on maximum and/or minimum permissible input signals 32 to maintain safe pool 50/spa 52 conditions and/or limit maintenance 46. For example, the energy saving protocol may provide an upper limit on a pump 31 speed, where the upper limit conserves energy while providing sufficient flow to not damage the pool 50 and/or spa 52. The energy saving protocol may provide a lower limit on a sanitation level to ensure the pool 50 and/or spa 52 does not become hazardous to a user. In this example, the pump 31 may function at any rate below the upper limit as long as the pump 31 maintains at least the lower limit of the sanitation level. The one or more command signals 22 may be output by the automation platform 14 based on the energy saving protocol.

In one example, the automation platform 14 may detect that the heat pump 31 is running during an extended period of nonuse, and may transmit a command signal 22 for shutting off the heat pump 31. In one nonlimiting example, the automation platform 14 may detect a flowrate or pump 31 speed is too high or low and may transmit a command signal 22 to adjust the flowrate and/or pump 31 speed. The automation platform 14 may apply artificial intelligence to learn and track patterns in pool 50 use, which may be used to identify energy efficiency optimization. The automation platform 14 may optimize chemical dosing. For example, the chemicals dispensed into the pool 50 and/or spa 52 may be dosed continuously and/or incrementally to maintain consistent levels of chemicals in the pool 50 and/or spa 52. A dose amount of one or more chemicals and/or timing of the dose may be determined by sensor 30 measurements in communication with the automation platform 14.

The automation platform 14 may detect maintenance 46 requirements of the pool infrastructure 15. The automation platform 14 may predict upcoming maintenance 46 requirements with one or more sensors 30 disposed on pool equipment network 19. The automation platform 14 may apply artificial intelligence and/or machine learning models to detect, learn, and analyze maintenance 46 requirements corresponding to pool infrastructure 15 usage. The automation platform 14 may transmit maintenance alerts 39 to the user through a user device 43 when a future maintenance 46 requirement is predicted by the automation platform 14.

The autonomous platform 14 may include a communication unit. The communication unit may allow the autonomous platform 14 to connect to other databases and the Internet through an input/output (I/O) interface, allowing the transfer as well as reception of data from other sources. The communication unit may include a modem, an Ethernet card, or other similar devices, which enable the computer system to connect to databases and networks, such as, LAN, MAN, WAN, and the Internet. The autonomous platform 14 may facilitate input from a user through input devices accessible to the system through an I/O interface.

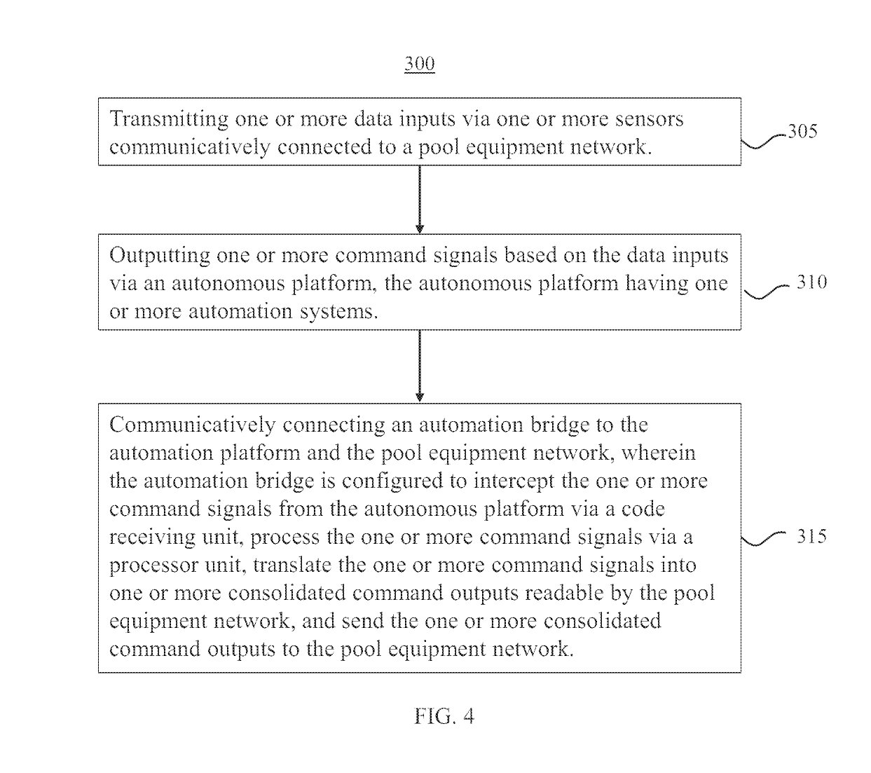

FIG. 4 is a flowchart 300 illustrating a method for integrating automation platforms and pool equipment networks in accordance with embodiments of the disclosure. It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

As shown by step 305, one or more data inputs are transmitted by one or more sensors communicatively connected to a pool equipment network. At step 310, one or more command signals based on the data inputs are output by an autonomous platform having one or more automation systems. At step 315, the automation bridge is communicatively connected to the automation platform and the pool equipment network, wherein the automation bridge is configured to intercept the one or more command signals from the autonomous platform via a code receiving unit, process the one or more command signals via a processor unit, translate the one or more command signals into one or more consolidated command outputs readable by the pool equipment network, and send the one or more consolidated command outputs to the pool equipment network. The method may include any of the components, features, or functionality described relative to FIGS. 1-3 herein.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and protected by the following claims.

What is claimed is:

1. A swimming pool equipment control system for integrating automation platforms and pool equipment networks, comprising:
a pool equipment network configured to receive one or more translated command outputs, the pool equipment network having one or more sensors configured to transmit one or more data inputs;
an autonomous platform configured to output one or more command signals based on the data inputs; and
an automation bridge communicatively connected to the one or more automation systems and one or more pool equipment systems, wherein the automation bridge is configured to:
intercept the one or more command signals from the autonomous platform via a code receiving unit;
process the one or more command signals via a processor unit;
translate the one or more command signals into one or more consolidated command outputs readable by the pool equipment network; and
send the one or more consolidated command outputs to the pool equipment network.

2. The system of claim 1, wherein the data inputs comprise one or more of a water temperature, at least one chemical level of water, a flowrate, or a pump speed.

3. The system of claim 1, wherein the pool equipment network comprises at least one of a pool safety system and one or more pool infrastructure, wherein the pool safety system and one or more pool infrastructure are configured to receive the one or more consolidated command outputs.

4. The system of claim 3, wherein the one or more pool infrastructure comprises a pump, wherein the pump is configured to adjust a water temperature in response to the consolidated command output.

5. The system of claim 4, wherein the automation platform is configured to:
identify an energy consumption via the one or more sensors;
initiate an energy saving protocol having:
an upper limit pump speed to conserve energy consumption; and
a lower limit sanitization level; and
output the one or more command signals based on the energy saving protocol.

6. The system of claim 3, wherein the one or more pool infrastructure comprises a chemical dispenser, wherein the chemical dispenser is configured to dispense a quantity of a chemical into a pool in response to the consolidated command output.

7. The system of claim 3, wherein the pool safety system comprises a safety monitoring system, wherein the autonomous platform is configured to alert a user when the safety monitoring system detects at least one of a harmful chemical level, an unsafe water temperature, or a hazardous weather condition.

8. The swimming pool equipment control system of claim 1, wherein the automation platform is configured to communicate with a user through a control interface, wherein the one or more control signals are based on an input by a user via the control interface.

9. The system of claim 8, wherein the automation platform is configured to, via a machine learning model, predict a maintenance requirement of the pool infrastructure based on the one or more data inputs, wherein the maintenance requirement is communicated to a user via the control interface.

10. A method for integrating automation platforms and pool equipment networks, comprising:
transmitting one or more data inputs via one or more sensors communicatively connected to a pool equipment network;
outputting one or more command signals based on the data inputs via an autonomous platform, the autonomous platform having one or more automation systems; and
communicatively connecting an automation bridge to the automation platform and the pool equipment network, wherein the automation bridge is configured to:
intercept the one or more command signals from the autonomous platform via a code receiving unit;
process the one or more command signals via a processor unit;
translate the one or more command signals into one or more consolidated command outputs readable by the pool equipment network; and
send the one or more consolidated command outputs to the pool equipment network.

11. The method of claim 10, wherein the data inputs comprise one or more of a water temperature, at least one chemical level of water, a flowrate, or a pump speed.

12. The method of claim 10, wherein the pool equipment network comprises at least one of a pool safety system and one or more pool infrastructure, wherein the pool safety system and one or more pool infrastructure are configured to receive the one or more consolidated command outputs.

13. The method of claim 12, adjusting a water temperature with a pump in response to the consolidated command output.

14. The method of claim 13, wherein the automation platform:
identifies an energy consumption via the one or more sensors;
initiate an energy saving protocol having:
an upper limit pump speed to conserve energy consumption; and
a lower limit sanitization level; and
outputs the one or more command signals based on the energy saving protocol.

15. The method of claim 12, wherein the one or more pool infrastructure comprises a chemical dispenser, further comprising dispensing, with the chemical dispenser, quantity of a chemical into the pool in response to the consolidated command output.

16. The method of claim 12, wherein the pool safety system comprises a safety monitoring system, further comprising alerting, with the safety monitoring system, a user when the safety monitoring system detects at least one of a harmful chemical level, an unsafe water temperature, or a hazardous weather condition.

17. The swimming pool equipment control system of claim 1, wherein the automation platform is configured to communicate with a user through a control interface, wherein the one or more control signals are based on an input by a user via the control interface.

18. A swimming pool lighting control system for connecting automation systems to lights, comprising:
an autonomous platform having one or more automation systems, the autonomous platform configured to output one or more command signals;
one or more lights; and
a lighting control module configured to:
intercept a command signal output by at least one automation system;
process a command signal via a processor unit;
translate the command signal into a consolidated command output; and
send the consolidated command output to at least one light having an input differing from the command signal output, wherein the at least one light is configured to receive the consolidated command output.

19. The system of claim 18, wherein the system further comprises two or more lights having a communication wiring scheme different from at least one other of the two or more lights.

20. The system of claim 19, wherein the one or more automation systems are configured to control two or more lights having a different communication wiring scheme via the lighting control module.
